(19) United States
(12) Patent Application Publication
(10) Pub. No.: US 2024/0369489 A1
(43) Pub. Date: Nov. 7, 2024

(54) MICROSCOPIC IMAGING APPARATUS AND ILLUMINATION CHIP THEREOF, IMAGING METHOD, ELECTRONIC DEVICE, AND MEDIUM

(71) Applicant: BGI SHENZHEN, Guangdong (CN)

(72) Inventors: Fan ZHOU, Guangdong (CN); Shaozhuang YANG, Guangdong (CN); Jielei NI, Guangdong (CN); Mengzhe SHEN, Guangdong (CN); Xun XU, Guangdong (CN)

(21) Appl. No.: 18/683,288

(22) PCT Filed: Aug. 16, 2021
(86) PCT No.: PCT/CN2021/112816

§ 371 Date: Feb. 13, 2024

(51) Int. Cl. G01N 21/64; G02B 21/00; G02B 21/06

(52) U.S. Cl. CPC G01N 21/6458; G01N 21/6428; G02B 21/0048; G02B 21/0076; G02B 21/06; G01N 2021/6439; G01N 2201/0636

(57) ABSTRACT

An illumination chip includes an illumination array structure and an illumination well. The illumination array structure includes a substrate and multiple illumination units periodically distributed on the substrate. The illumination well is disposed on a surface, extending along the multiple illumination units, of the illumination array structure, where the illumination well is divided into multiple placement units which are configured to place samples, and each placement unit (841) is disposed above a corresponding illumination unit. Illumination units of the multiple illumination units are configured to generate, in a case where the illumination units of the multiple illumination units are illuminated by a light source, surface plasmon structured light to excite fluorescent dyes of samples in corresponding placement units of the multiple placement units, and generate a fluorescence signal.

### TECHNICAL FIELD

The present disclosure relates to the field of optical imaging technologies and, in particular, to a super-resolution microscopic imaging apparatus and an illumination chip thereof, an imaging method, an electronic device, and a medium.

### BACKGROUND

The resolution of a traditional optical microscopic imaging system is limited by the optical diffraction limit, preventing the development of optical microscopic imaging techniques. The optical diffraction limit theory was proposed by the German scientist E. Abbe in 1873. The resolution of an optical system cannot exceed λ/(2*NA), where λ denotes the wavelength of the incident light and NA denotes the numerical aperture of the optical system. This theory led scientists for much of the 20th century to believe that people would never be able to observe the finer dimensions by the optical microscopic imaging techniques, such as the interactions of individual molecules inside a cell.

However, the diffraction limit theory was broken at the end of the 20th century. There are currently a variety of mature super-resolution microscopic imaging methods in the world, such as structured illumination microscopy (SIM), stimulated emission depletion microscopy (STED), and stochastic optical reconstruction microscopy (STORM). Structured illumination microscopy was proposed by Professor Gustafsson in 2000 and is as follows: based on widefield microscopy, structured light with periodic intensity modulation is used to illuminate samples, high-frequency information is extracted through a specific algorithm, and a super-resolution image is reconstructed to achieve breakthroughs in the diffraction limit. Compared with other super-resolution methods, structured illumination microscopy has the advantages of fast imaging speed, low dye requirements, a simple optical path structure, little photodamage, and applicability to real-time dynamic three-dimensional imaging of living cells and is widely used in the biomedical field.

Through traditional SIM, based on the frequency domain solution, reconstructing the super-resolution image requires taking at least nine consecutive images. According to the reconstruction method proposed by Professor Gustafsson, three different phase values need to be acquired in each illumination direction, and the high-frequency information is obtained by solving a system of linear equations, so three images need to be taken. In addition, to obtain the super resolution in each direction, the illumination direction needs to be rotated by three angles (generally 0°, 60°, and 120°), that is, a total of nine images are required. Sometimes, to obtain finer reconstructed data, a larger number of images need to be collected. In addition, the reconstruction algorithm based on the frequency domain solution inevitably introduces artifacts, confusing the judgment of the true morphology of the observed sample structure.

To sum up, the existing microscopic imaging method generally has the defects described below.

1) At least nine images need to be taken, affecting the real-time performance of taking pictures and resulting in low system throughput.

2) The frequency domain algorithm reconstruction inevitably introduces artifacts, affecting sample observation.

3) Multiple images need to be collected continuously in different phases and different directions of rotation, requiring high precision of the structured light phase and angle of rotation, in turn requiring high positioning precision of the mechanical parts that control the grating, and increasing the difficulty and cost of system construction.

### SUMMARY

A main object of the present disclosure is to provide a microscopic imaging apparatus and an illumination chip thereof, an imaging method, an electronic device, and a medium to improve the preceding defects existing in the existing art.

The present disclosure solves the preceding technical problems through the technical solutions described below:

According to an aspect of the present disclosure, an illumination chip for a microscopic imaging apparatus is provided. The illumination chip includes an illumination array structure and an illumination well. The illumination array structure includes a substrate and multiple illumination units periodically distributed on the substrate. The illumination well is disposed on a surface, extending along the multiple illumination units, of the illumination array structure, where the illumination well is divided into multiple placement units which are configured to place samples, and each placement unit is disposed above a corresponding illumination unit. Illumination units of the multiple illumination units are configured to generate, in a case where the illumination units of the multiple illumination units are illuminated by a light source, surface plasmon structured light to excite fluorescent dyes of samples in corresponding placement units of the multiple placement units, and generate a fluorescence signal.

As an optional embodiment, the illumination chip further includes a substrate layer disposed on the substrate, where the multiple illumination units are separately disposed in the substrate layer, and the illumination well is disposed on a surface, extending along the multiple illumination units, of the substrate layer.

As an optional embodiment, the substrate layer includes a first substrate layer and a second substrate layer. The multiple illumination units are disposed in the first substrate layer. The second substrate layer is configured to be disposed between an upper surface of the multiple illumination units extending along the multiple illumination units and a lower surface of the illumination well in contact with the substrate layer.

As an optional embodiment, the material of the substrate layer includes silicon dioxide.

As an optional embodiment, at least every two placement units are distributed on two sides of a corresponding illumination unit, respectively.

As an optional embodiment, a placement unit is distributed in a symmetrical manner on a left side or a right side of an illumination unit.

In a case where a respective illumination unit of the multiple illumination units is illuminated by the light source at symmetrical illumination angles, the respective illumination unit is configured to generate the surface plasmon structured light to excite fluorescent dyes of samples in placement units disposed on the left side and the right side of the respective illumination unit.

As an optional embodiment, the multiple illumination units are periodically distributed on the substrate and form regular polygons.

As an optional embodiment, the illumination unit includes an illumination pillar.

As an optional embodiment, the illumination pillar includes an illumination cylinder.

As an optional embodiment, the material of the substrate includes the light-transmissive material; and/or the material of the multiple illumination units includes the metal material; and/or the material of the illumination well includes the opaque material.

According to another aspect of the present disclosure, a microscopic imaging apparatus is provided. The microscopic imaging apparatus includes the illumination chip for the microscopic imaging apparatus, a light source, a beam angle control device, and an imaging processing device. The light source is configured to illuminate light to the illumination chip. The beam angle control device is configured to adjust an illumination angle of the light from the light source to the illumination chip. The imaging processing device is configured to generate at least two original images according to fluorescence signals generated on the illumination chip at different illumination angles and perform superimposition processing on the at least two original images to generate a microscopic image.

As an optional embodiment, the microscopic imaging apparatus further includes a collimating lens, a reflector, a lens, a dichroic mirror, an objective lens, and a tube lens. The collimating lens is configured to receive the light illuminated by the light source and emit collimated light to the reflector. The reflector is configured to reflect the light to the beam angle control device. The beam angle control device is configured to receive the light from the reflector and emit emergent light at a first angle of emergence to the lens. The lens is configured to emit converging light to the dichroic mirror. The dichroic mirror is configured to reflect the received converging light to the objective lens. The objective lens is configured to illuminate emergent light at a third angle of emergence to the illumination chip to generate the fluorescence signals. The objective lens is further configured to collect the fluorescence signals generated on the illumination chip and transmit the fluorescence signals to the tube lens through the dichroic mirror. The tube lens is configured to converge the received fluorescence signals onto the imaging processing device.

As an optional embodiment, the microscopic imaging apparatus further includes a collimating lens, a first reflector, a second reflector, a first converging lens, a second converging lens, an objective lens, and a tube lens. The collimating lens is configured to receive the light illuminated by the light source and emit collimated light to the first reflector. The first reflector is configured to reflect the light to the beam angle control device. The beam angle control device is configured to receive the light from the first reflector and emit emergent light at a first angle of emergence to the first converging lens. The second reflector is configured to reflect converging light converged by the first converging lens to the second converging lens. The second converging lens is configured to illuminate emergent light at a second angle of emergence to the illumination chip. The objective lens is configured to collect the fluorescence signals generated on the illumination chip. The tube lens is configured to converge the fluorescence signals collected by the objective lens onto the imaging processing device.

As an optional embodiment, the beam angle control device is configured to set the switching time of the illumination angle to be less than 1 ms.

As an optional embodiment, the beam angle control device includes a scanning galvanometer.

As an optional embodiment, the light source includes any one or more of a laser light source, a light-emitting diode (LED) light source, or a mercury-vapor lamp.

According to another aspect of the present disclosure, a microscopic imaging method is provided. The method includes acquiring at least two original images, where the at least two original images are generated through fluorescent signals generated on the preceding illumination chip for a microscopic imaging apparatus at different illumination angles; and performing superimposition processing on the at least two original images to generate a microscopic image.

According to another aspect of the present disclosure, an electronic device is provided. The electronic device includes a memory, a processor, and a computer program stored in the memory and executable by the processor, where the processor, when executing the computer program, performs the preceding microscopic imaging method.

According to another aspect of the present disclosure, a computer-readable medium is provided.

The computer-readable medium stores computer instructions which, when executed by a processor, cause the processor to perform the preceding microscopic imaging method.

Based on common sense in the art, the optional conditions described above can be combined arbitrarily so as to obtain preferred embodiments of the present disclosure.

Other aspects of the present disclosure are apparent to those skilled in the art according to the present disclosure.

The positive and progressive effects of the present disclosure are as follows: for biological samples arranged in an array, the illumination angle of the incident light is changed so that the samples can be selectively excited effectively, and at least 2-fold improvement in resolution can in be achieved just by at least two images, thereby effectively reducing the number of original images: a frequency domain reconstruction algorithm is not needed, fewer artifacts are produced, sample observation is not affected, and the construction difficulty and production cost of the microscopic imaging apparatus are effectively reduced.

### BRIEF DESCRIPTION OF DRAWINGS

The described features and advantages of the present disclosure can be better understood after reading the detailed description of embodiments of the present disclosure in conjunction with the drawings below. In the drawings, components are not necessarily drawn to scale, and components with similar related properties or characteristics may have the same or similar reference numerals.

FIG. 1 is a structural diagram of a microscopic imaging apparatus according to an embodiment of the present disclosure;

FIG. 2 is a sectional diagram of an illumination chip used in a microscopic imaging apparatus:

FIG. 3 is a top diagram of an illumination array structure of an illumination chip used in a microscopic imaging apparatus;

FIG. 4 is a perspective diagram of an illumination array structure of an illumination chip used in a microscopic imaging apparatus:

FIG. 5 is a perspective diagram of an illumination chip used in a microscopic imaging apparatus:

FIG. 6 is a schematic diagram illustrating the distribution of placement units of an illumination chip used in a microscopic imaging apparatus:

FIG. 7 is a schematic diagram illustrating the energy distribution of surface plasmon structured light generated by illumination units at an illumination angle of a light source:

FIG. 8 is a schematic diagram illustrating the energy distribution of surface plasmon structured light generated by illumination units at another illumination angle of a light source:

FIG. 9 is a schematic diagram illustrating that samples are periodically distributed on an illumination chip for a microscopic imaging apparatus;

FIG. 10 is a schematic diagram illustrating that the surface plasmon structured light generated at an illumination angle of a light source illuminates a sample on the left side of an illumination unit;

FIG. 11 is a schematic diagram illustrating that the surface plasmon structured light generated at another illumination angle of a light source illuminates a sample on the right side of an illumination unit;

FIG. 12 is a structural diagram of a microscopic imaging apparatus according to another embodiment of the present disclosure;

FIG. 13 is a flowchart of a microscopic imaging method according to another embodiment of the present disclosure; and

FIG. 14 is a structural diagram of an electronic device for performing a microscopic imaging method according to another embodiment of the present disclosure.

Reference list

| | |
|---|---|
| 1 | light source |
| 2 | collimating lens |
| 3 | first reflector |
| 3′ | reflector |
| 4 | beam angle control device |
| 5 | first converging lens |
| 6 | second reflector |
| 7 | second converging lens |
| 8 | illumination chip |
| 81 | substrate |
| 821 | first substrate layer |
| 822 | second substrate layer |
| 83 | illumination unit |
| 84 | illumination well |
| 841 | placement unit |
| 9 | sample |
| 10 | objective lens |
| 11 | tube lens |
| 12 | imaging processing device |
| 13 | lens |
| 14 | dichroic mirror |
| 30 | electronic device |
| 31 | processor |
| 32 | memory |
| 321 | random-access memory (RAM) |
| 322 | cache memory |
| 323 | read-only memory (ROM) |
| 324 | program module |
| 325 | program |
| 33 | bus |
| 34 | external device |
| 35 | input/output (I/O) interface |
| 36 | network adapter |

### DETAILED DESCRIPTION

The present disclosure is further described below through embodiments, but the present disclosure is not limited to the scope of the described embodiments.

It is to be noted that references in the specification to “an embodiment,” “an optional embodiment,” “another embodiment,” and the like indicate that the described embodiment may include specific features, structures, or characteristics, but each embodiment may not necessarily include the specific features, structures, or characteristics. Moreover, such phrases do not necessarily refer to the same embodiment. Further, when the specific features, structures, or characteristics are described in conjunction with the embodiments, whether or not explicitly described, it is within the knowledge of those skilled in the art to implement such features, structures, or characteristics in conjunction with other embodiments.

In the description of the present disclosure, it is to be understood that the orientations or position relations indicated by terms “center”, “horizontal”, “up”, “down”, “left”, “right”, “vertical”, “horizontal”, “top”, “bottom”, “inside”, “outside”, and the like are based on the drawings, which are for the mere purpose of facilitating and simplifying the description of the present disclosure. These orientations or position relations do not indicate or imply that the device or component referred to must have a specific orientation and be constructed and operated in a specific orientation, and thus it is not to be construed as limiting the present disclosure. Moreover, terms such as “first” and “second” are used only for the purpose of description and are not to be construed as indicating or implying relative importance or implicitly indicating the number of technical features indicated. Thus a feature defined as a “first” feature or a “second” feature may explicitly or implicitly include one or more of such features. In the description of the present disclosure, unless otherwise noted, “multiple” means two or more. In addition, terms “including” and “having” or any variations thereof are intended to encompass a non-exclusive inclusion.

In the description of the present disclosure, it is to be noted that unless otherwise expressly specified and limited, the term “mounted”, “connected to each other”, or “connected” is to be construed in a broad sense as securely connected, detachably connected, or integrated; mechanically connected or electrically connected: directly connected to each other or indirectly connected to each other via an intermediary: or internal communication between two components. For those of ordinary skill in the art, specific meanings of the preceding terms in the present disclosure may be understood based on specific situations.

The terms used herein are merely for the purpose of describing the embodiments and are not intended to limit the example embodiments. As used herein, the singular forms “a” and “an” are intended to include the plural as well, unless the context clearly indicates otherwise. It is also to be understood that the terms “comprising” and/or “including” as used herein specify the presence of stated features, integers, steps, operations, units, and/or components without excluding the presence or addition of one or more other features, integers, steps, operations, units, components, and/or combinations thereof.

To overcome the preceding defects currently existing, this embodiment provides a microscopic imaging apparatus. The microscopic imaging apparatus includes an illumination chip for the microscopic imaging apparatus, a light source, a light source adjustment mechanism, and an imaging processing device. The light source is configured to illuminate light to the illumination chip. The light source adjustment mechanism is configured to adjust an illumination angle of the light from the light source to the illumination chip. The imaging processing device is configured to generate at least two original images according to fluorescence signals generated on the illumination chip at different illumination angles and perform superimposition processing on the at least two original images to generate a microscopic image.

The illumination chip for the microscopic imaging apparatus includes an illumination array structure and an illumination well. The illumination array structure includes a substrate and multiple illumination units periodically distributed on the substrate. The illumination well is disposed on a surface, extending along the multiple illumination units, of the illumination array structure, where the illumination well is divided into multiple placement units which are configured to place samples, and each placement unit is disposed above a corresponding illumination unit. Illumination units of the multiple illumination units are configured to generate, in a case where the illumination units of the multiple illumination units are illuminated by the light source, surface plasmon structured light to excite fluorescent dyes of samples in corresponding placement units of the multiple placement units, and generate a fluorescence signal.

In this embodiment, the periodically distributed samples may be, for example, deoxyribonucleic acid (DNA) nanoballs in a sequencer, quantum dots, fluorescent nanospheres, and the like. Of course, this embodiment does not specifically limit the type of samples, and corresponding settings and adjustments can be made according to actual requirements, actual scenarios, or possible requirements and scenarios.

In this embodiment, for the samples arranged periodically in an array, the illumination angle of the incident light is changed so that the samples can be selectively excited effectively, and at least 2-fold improvement in resolution can be achieved just by at least two images, thereby effectively reducing the number of original images: a frequency domain reconstruction algorithm is not needed, fewer artifacts are produced, sample observation is not affected, and the construction difficulty and production cost of the microscopic imaging apparatus are effectively reduced.

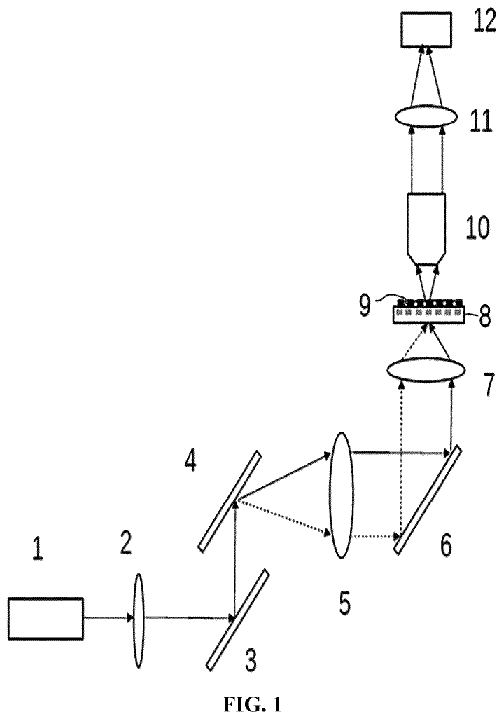

Specifically, as an embodiment, as shown in FIG. 1, the microscopic imaging apparatus provided in this embodiment mainly includes, but is not limited to, a light source 1, a collimating lens 2, a first reflector 3, a beam angle control device 4, a first converging lens 5, a second reflector 6, a second converging lens 7, an illumination chip 8 for the microscopic imaging apparatus, an objective lens 10, a tube lens 11, an imaging processing device 12, and a computer (not shown in the figure).

The light source 1 is configured to illuminate light to the illumination chip 8. The collimating lens 2 is configured to receive the light illuminated by the light source 1 and emit collimated parallel light to the first reflector 3. The first reflector 3 is configured to reflect the light to the beam angle control device 4. The beam angle control device 4 is configured to receive the light from the first reflector 3 and emit emergent light at a first angle of emergence to the first converging lens 5. The second reflector 6 is configured to reflect converging light converged by the first converging lens 5 to the second converging lens 7. The second converging lens 7 is configured to illuminate emergent light at a second angle of emergence (the angle from the normal to the incident surface, for example, 60 degrees) to the illumination chip 8 and generate surface plasmon structured light to excite fluorescent dyes in samples 9 and generate fluorescence signals. The objective lens 10 is configured to collect the fluorescence signals generated on the illumination chip 8. The tube lens 11 is configured to converge the fluorescence signals collected by the objective lens 10 onto the imaging processing device 12.

The imaging processing device 12 is communicatively connected to the computer and is configured to generate at least two original images according to the fluorescence signals generated on the illumination chip 8 at different illumination angles (for example, 60 degrees and −60 degrees as symmetrical angles) and perform superimposition processing on the at least two original images to generate a super-resolution microscopic image.

As a preferred embodiment, the beam angle control device 4 is configured to set the switching time of the illumination angle to 1 ms or less so that the switching time is much less than the time required for displacement and rotation platform movement in a traditional structured light microscopic imaging method.

As an optional example, the beam angle control device 4 can use a rotation movement platform to drive the reflector to rotate to control the illumination angle of the light. The beam angle control device 4 includes a scanning galvanometer, preferably a single-axis scanning galvanometer, and more specifically; an XY scanning galvanometer, but the type of the beam angle control device 4 is not specifically limited. As long as the corresponding functions can be implemented, corresponding settings and adjustments can be made according to actual requirements, actual scenarios, or possible requirements and scenarios.

In this embodiment, the microscopic imaging apparatus changes the illumination angle of the incident light just by the scanning galvanometer and does not need to rotate and translate the grating, thereby effectively reducing the construction difficulty and production cost of the microscopic imaging apparatus.

In this embodiment, the light source 1 includes any one or more of a laser light source, a light-emitting diode (LED) light source, or a mercury-vapor lamp. However, the type of the light source 1 is not specifically limited. As long as the corresponding functions can be implemented, corresponding settings and adjustments can be made according to actual requirements, actual scenarios, or possible requirements and scenarios.

The structure of the illumination chip 8 and the samples 9 placed on the illumination chip 8 are described in detail below:

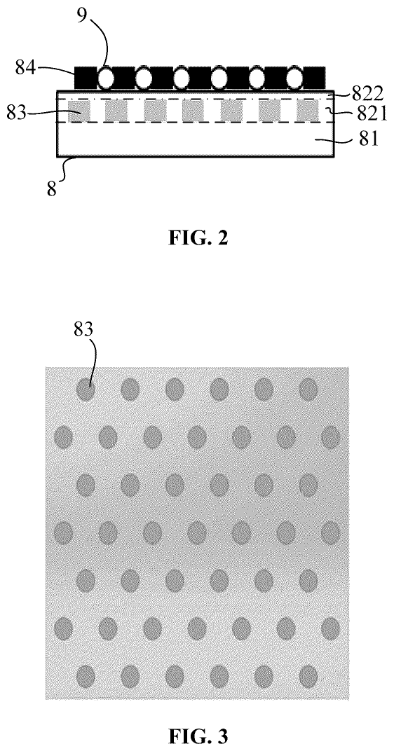

As shown in FIGS. 2 and 5, the illumination chip 8 (also called a nanochip) mainly includes an illumination array structure (also called a nanoarray structure) and an illumination well 84 (also called a nanowell).

As an optional embodiment, the illumination array structure mainly includes a substrate 81, a substrate layer (the material of the substrate layer includes silicon dioxide), and multiple illumination units 83. The substrate layer is disposed on the substrate 81. The multiple illumination units 83 are periodically arranged in the substrate layer and distributed on the substrate 81, forming regular hexagons (or other shapes such as regular quadrilaterals). The illumination well 84 is disposed on a surface, extending along the illumination units 83, of the substrate layer.

As a preferred embodiment, referring to FIG. 2, the substrate layer mainly includes a first substrate layer 821 and a second substrate layer 822 (the dashed lines in FIG. 2 are only drawn for illustration and not for the physical division, and the first substrate layer 821 and the second substrate layer 822 may be made of exactly the same materials). Multiple illumination units 83 are disposed in the first substrate layer 821. The height of the first substrate layer 821 corresponds to the height of the illumination units 83, for example, 80 nm. The second substrate layer 822 is configured to be disposed between an upper surface of the illumination units 83 extending along the illumination units 83 and a lower surface of the illumination well 84 in contact with the substrate layer. The second substrate layer 822 can protect the illumination units 83 and can also effectively prevent corrosion. Therefore, the height of the second substrate layer 822 can be set according to actual requirements, for example, 20 nm.

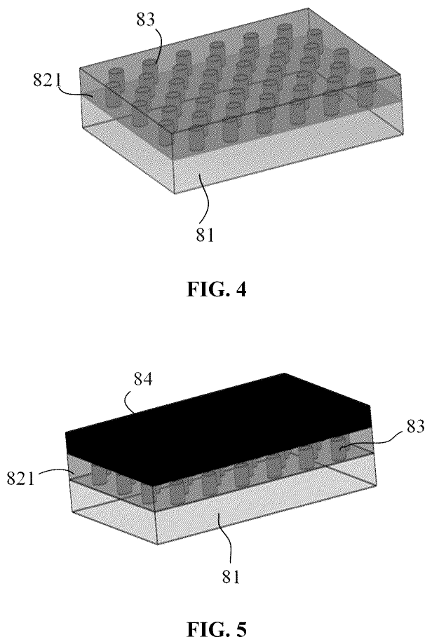

As a preferred embodiment, referring to FIGS. 3 and 4, the illumination unit 83 may be an illumination pillar, preferably, an illumination cylinder. The illumination unit 83 may be solid metal, and the solid metal may be preferably silver, copper, aluminum, gold, or the like. Of course, this embodiment does not specifically limit the shape and material of the illumination unit 83. As long as the corresponding functions can be implemented, corresponding settings and adjustments can be made according to actual requirements, actual scenarios, or possible requirements and scenarios.

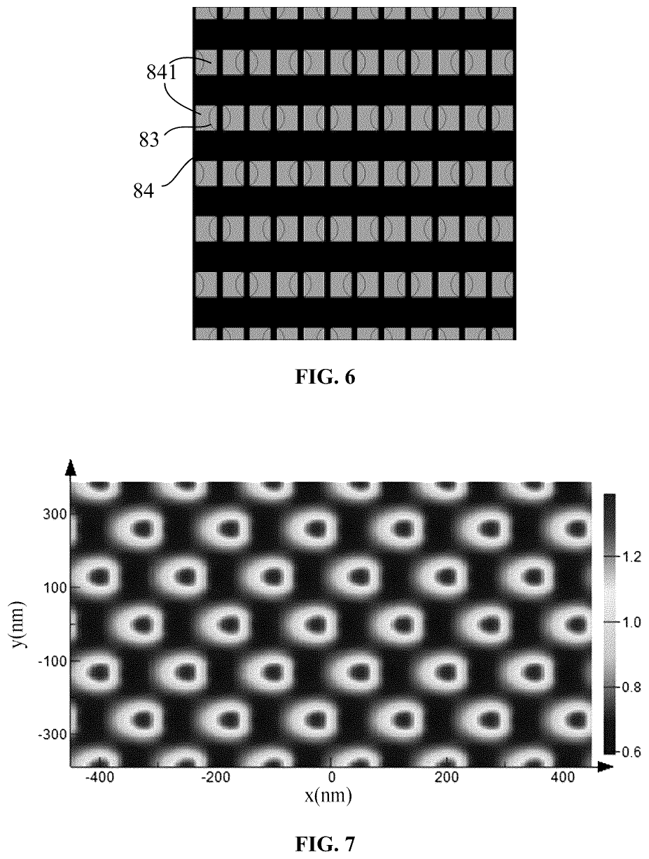

Referring to FIGS. 2 and 6, the illumination well 84 is divided into multiple placement units 841 for placing the samples 9, and each placement unit 841 is disposed above a corresponding illumination unit 83. Illumination units 83 of the multiple illumination units 83 are configured to generate, in a case where the illumination units 83 of the multiple illumination units 83 are illuminated by the light source, surface plasmon structured light to excite fluorescent dyes of samples 9) in corresponding placement units 841 of the multiple placement units 841, and generate a fluorescence signal.

As a preferred embodiment, taking into account the surface ion effect, as shown in FIG. 6, the placement unit is distributed in a symmetrical manner on the left side or right side of the illumination unit 83. In a case where a respective illumination unit 83 of the multiple illumination units 83 is illuminated by the light source at symmetrical illumination angles, the respective illumination unit 83 is configured to generate the surface plasmon structured light to excite fluorescent dyes of samples in placement units 841 disposed on the left side and the right side of the respective illumination unit 83.

Specifically; the illumination chip in this embodiment has a special structural design for characteristics including periodically distributed samples and surface plasmon illumination. The material of the substrate includes the light-transmissive material (for example, quartz, BK7, and other high-transmittance materials) so that the light source can illuminate the illumination units through the substrate. The illumination well structure can be designed strictly according to the illumination array structure. The length and width parameters of the placement units of the illumination well are determined according to the distance between the illumination units, and the height of the illumination well is determined according to the dimensions of the samples. The material of the illumination well includes the opaque material, such as titanium nitride (TiN), thereby ensuring that the plasmon structured light generated when the angle of the incident light changes does not excite the neighboring sample.

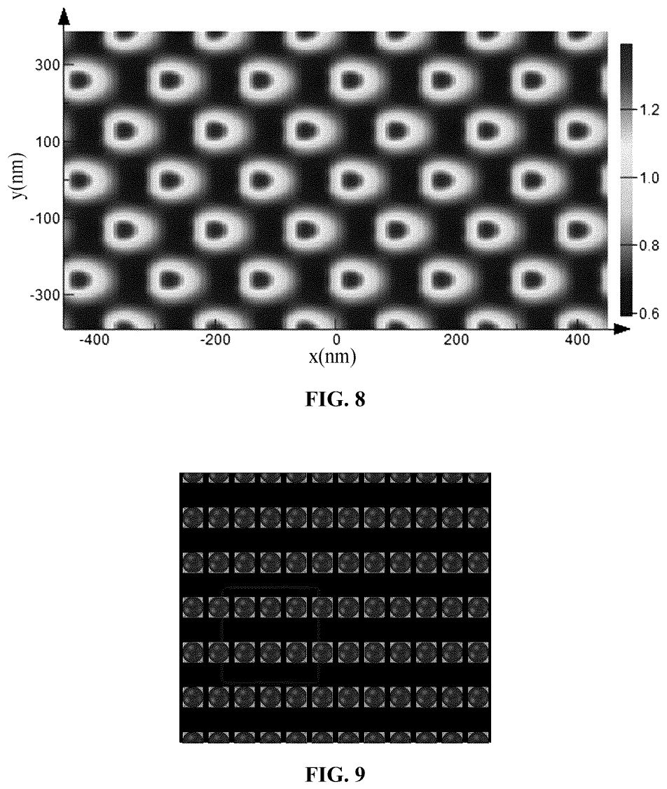

Different materials and dimension parameters are selected for the illumination units according to the laser wavelength and resolution requirements in conjunction with finite element analysis and simulation. For example, with 532 nm laser excitation, according to finite element analysis and simulation, in the case where the material of the illumination unit is silver, the diameter is 60 nm, the height is 60 nm, and the pitch (referring to the distance between the centers of two adjacent illumination units (that is, the illumination cylinders)) is 150 nm, the surface plasmons have better resonance energy and satisfy the resolution improvement requirements. At different illumination angles of the light source, different surface plasmon energy distributions are produced. Refer to FIGS. 7 and 8, the illumination unit is shown in a white circle, and the inside of the colored circle shows the excitation degree (the closer it is to the internal, the stronger the excitation degree is). The illumination angles are +60 degrees (corresponding to FIG. 7) and −60 degrees (corresponding to FIG. 8), and the surface plasmons generated at the two symmetrical angles are symmetrically distributed on the left and right sides of the illumination unit. The upper illumination well is designed according to this characteristic.

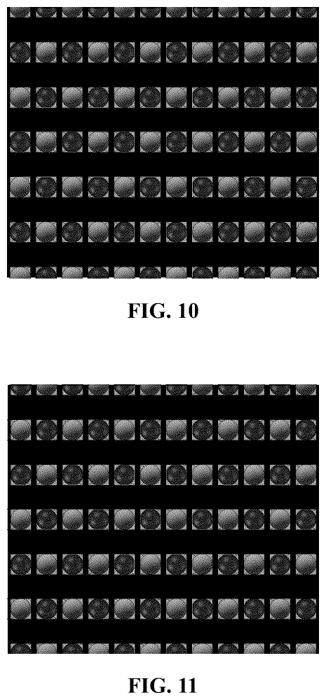

FIG. 9 shows the samples on the surface of the illumination chip not illuminated by the laser, and the unexcited sample in the figure is shown in a black circle. When the laser illuminates the illumination chip, the generated surface plasmons excite the fluorescent dye in the samples. The illumination angle is changed symmetrically, and the samples distributed on the left and right sides of the illumination units are excited in sequence. FIG. 10 shows that the samples on the left side of the illumination units are excited (considered in conjunction with the arrangement of the illumination units in FIG. 6), and the excited sample is shown in a gray circle. FIG. 11 shows that the samples on the right side of the illumination units are excited (considered in conjunction with the arrangement of the illumination units in FIG. 6), and the excited sample is also shown in a gray circle.

The following is a detailed description of the process of using the preceding microscopic imaging apparatus to acquire the super-resolution microscopic image.

In this embodiment, only two original images need to be collected, and no reconstruction algorithm is needed to directly synthesize the super-resolution microscopic image. The following process steps are mainly included.

A. The excitation light illuminates the beam angle control device through the collimating lens and the first reflector. The laser is emitted at a certain angle. As shown in the dashed lines in FIG. 1, after the light is converged by the first converging lens, the light illuminates the second converging lens through the second reflector, and finally, the light illuminates the illumination chip at a certain angle (for example, +60 degrees). The laser excites the illumination array structure and generates the surface plasmon structured light. As shown in FIG. 7, the plasmons are limited to the left side of the illumination units, the illumination well structure is designed according to the illumination array structure, and every two placement units are distributed on the left and right sides of the illumination unit as shown in FIG. 6. Therefore, the plasmon structured light excites only the sample in the placement unit on the left side above the illumination unit, the illuminated sample produces the fluorescence signal as shown in FIG. 10 (the white indicates the generated fluorescence signal), and the objective lens collects the fluorescence signal generated by the sample. The tube lens focuses the fluorescence signal on the imaging processing device, the optical signal is converted into the electrical signal, and the electrical signal is transmitted to the computer so as to form the first original image.

B. The beam angle control device is controlled to change the angle of the emergent light, where the angle is symmetrical to the angle in step A. As shown by the solid lines in FIG. 1, the excitation light finally illuminates the illumination chip at a certain angle (for example, −60 degrees), and the laser excites the illumination array structure to generate the surface plasmon structured light. As shown in FIG. 8, the plasmons are limited on the right side of the illumination units, the sample in the placement unit on the right side above the illumination unit is excited, the sample on the right side is excited to generate the fluorescence signal as shown in FIG. 11, the objective lens collects the fluorescence signal generated by the sample, and the tube lens focuses the fluorescence signal on the imaging processing device so as to form the second original image.

C. Spatial domain image superimposition is performed on the two collected original images so as to obtain the super-resolution microscopic image. Depending on the application, subsequent image processing and related data processing are performed.

In this embodiment, in the case where multi-color dye is involved, lasers of different wavelengths need to be triggered, that is, the original images are separately collected using the lasers of different wavelengths, and the super-resolution microscopic image is synthesized. The specific steps of collecting the original images and synthesizing the image are described as the preceding steps A to C, and the preceding steps A to C can be repeated each time, so the details are not repeated.

The specific angle at which the light finally illuminates the illumination chip in step A needs to be determined according to time domain finite element analysis and simulation and is related to the dimension, material, incident wavelength, and other parameters of the illumination array structure. For example, for the 532 nm excitation light source, silver cylinders (that is, the illumination units) with a height of 60 nm and a diameter of 60 nm are laid on the substrate. In the case where the illumination units are periodically distributed and form regular hexagons, +60 degrees and −60 degrees are recommended according to the time domain finite element analysis and simulation results.

The angle of the emergent light of the beam angle control device needs to be controlled and is calculated according to the magnification of the lens group formed by the first converging lens and the second converging lens in conjunction with the angle at the illumination chip. For example, if the magnification of the lens group is 2 times and the illumination angles of the illumination chip are +60 degrees and −60 degrees, then the angle of the emergent light of the beam angle control device is ±60 degrees/2, that is, +30 degrees and −30 degrees.

The microscopic imaging apparatus and the illumination chip provided in this embodiment mainly have the beneficial effects described below:

1) The beam angle control device only needs to be controlled to change the angle of the emergent light twice. The switching time is usually less than 1 ms and is much less than the displacement and rotation platform movement time used in the traditional structured illumination microscopy: The system has obvious advantages in real-time performance and throughput, and therefore, dye photobleaching and sample photodamage can be avoided, which is especially suitable for a light-sensitive dye and biological samples.

2) The microscopic imaging image reconstruction requires only simple spatial domain processing instead of complex frequency domain algorithm processing, thereby reducing artifacts and obtaining the most realistic sample morphology results. This is very important for quantitative analysis applications and can effectively improve the accuracy of the analysis results. For example, in second-generation gene sequencing. DNA nanoballs are regularly arranged on the chip, and the identification accuracy directly affects the reliability of the final sequencing result. The frequency domain reconstruction algorithm in the traditional structured illumination microscopy cannot avoid the introduction of artifacts, affecting the identification accuracy.

3) The optical path of the microscopic imaging apparatus is simple so that the construction difficulty is reduced, the microscopic imaging apparatus is compatible with the commonly used microscopic imaging system, and the production cost is reduced.

4) At least 2-fold improvement in resolution of the outputted super-resolution microscopic image can be achieved theoretically.

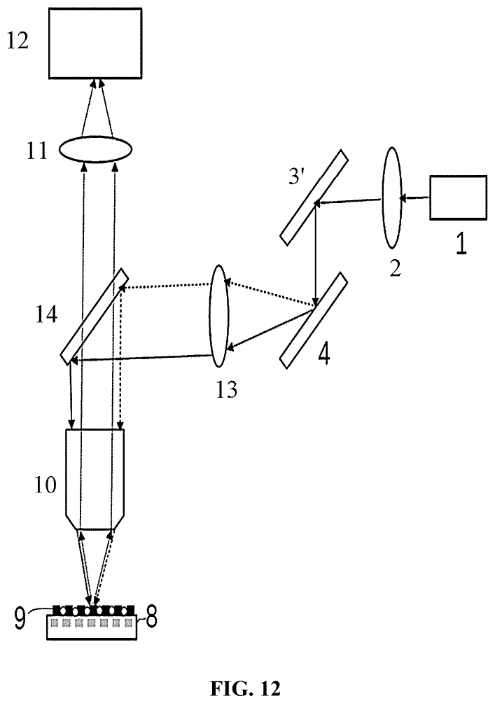

As another embodiment, as shown in FIG. 12, the microscopic imaging apparatus provided in this embodiment mainly includes a light source 1, a collimating lens 2, a reflector 3′, a beam angle control device 4, a lens 13, a dichroic mirror 14, an objective lens 10, a tube lens 11, an imaging processing device 12, and a computer (not shown in the figure).

For the structures and functions of the light source 1, the collimating lens 2, the reflector 3′, the beam angle control device 4, the tube lens 11, the imaging processing device 12, and the computer, reference may be made to the corresponding components in the preceding embodiments, so the details are not repeated.

In this embodiment, the illumination optical path is mainly replaced from the projection type as mentioned above to the reflection type. Specifically, as shown in FIG. 12, the collimating lens 2 is configured to receive the light illuminated by the light source 1 and emit collimated light to the reflector 3′: the reflector 3′ is configured to reflect the light to the beam angle control device 4; the beam angle control device 4 is configured to receive the light from the reflector 3′ and emit emergent light at a first angle of emergence to the lens 5: the lens 5 is configured to emit converging light to the dichroic mirror 14: the dichroic mirror 14 is configured to reflect the received converging light to the objective lens 10: the objective lens 10 is configured to illuminate emergent light at a third angle of emergence to the illumination chip 8 to generate the surface plasmon structured light to excite the samples 9 in the illumination well to emit the fluorescence signals: the objective lens 10 is further configured to collect the fluorescence signals generated on the illumination chip 8 and transmit the fluorescence signals to the tube lens 11 through the dichroic mirror 14: the tube lens 11 is configured to converge the received fluorescence signals onto the imaging processing device 12: the imaging processing device 12 is configured to acquire the first original image, and then the beam angle control device 4 is controlled to change to the symmetrical angle of the emergent light; and the imaging processing device 12 is further configured to acquire the second original image and superimpose the two original images to form the super-resolution microscopic image.

In the microscopic imaging apparatus provided in this embodiment, for the biological samples arranged in an array, the illumination angle of the incident light is changed so that the samples can be selectively excited effectively, and at least 2-fold improvement in resolution can be achieved just by at least two images, thereby effectively reducing the number of original images: a frequency domain reconstruction algorithm is not needed, fewer artifacts are produced, sample observation is not affected, and the construction difficulty and production cost of the microscopic imaging apparatus are effectively reduced.

The microscopic imaging apparatus in the present disclosure is not limited to second-generation gene sequencing. If the microscopic imaging apparatus is applied to a second-generation gene sequencing system, sequencing throughput can be improved, photobleaching and optical loss can be reduced, which is also important for sequencing, artifacts can be reduced, and the DNA nanoball (DNB) identification rate can be improved, thereby increasing the Q30 (sequencing data) data value.

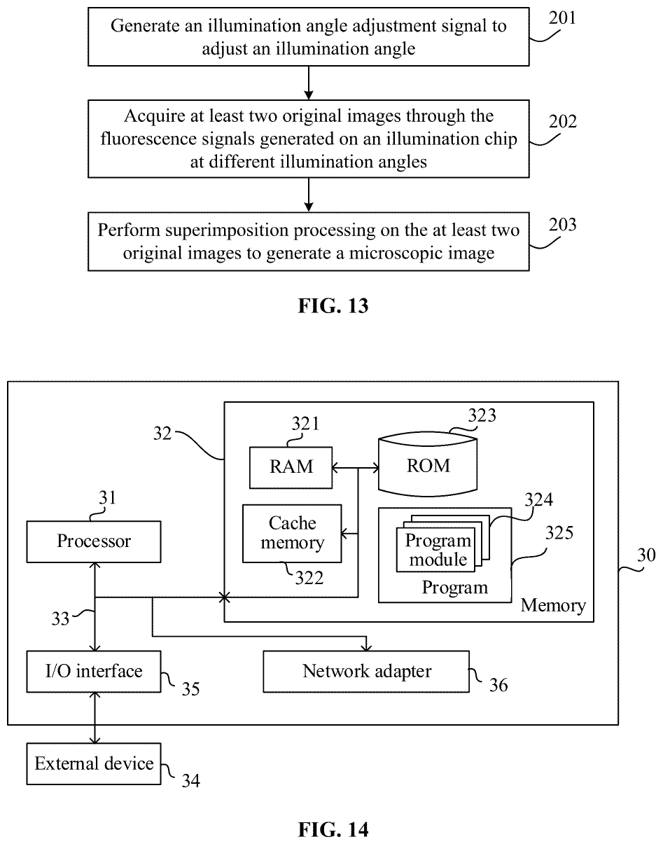

To overcome the preceding defects currently existing, as another embodiment, as shown in FIG. 13, this embodiment provides a microscopic imaging method. The method mainly includes the steps described below.

In step 201, an illumination angle adjustment signal is generated to adjust an illumination angle.

In step 202, at least two original images are acquired through the fluorescence signals generated on an illumination chip at different illumination angles.

In step 203, superimposition processing is performed on the at least two original images to generate a microscopic image.

In step 201, the illumination angle adjustment signal for the preceding light source adjustment mechanism of the microscopic imaging apparatus is generated and outputted to the light source adjustment mechanism to adjust the illumination angle of the light from the light source to the illumination chip.

In step 202, the at least two original images are acquired, where the at least two original images are generated through the fluorescent signals generated on the preceding illumination chip for the microscopic imaging apparatus at different illumination angles.

In step 203, superimposition processing may be performed on the at least two original images by using the existing image superimposition processing method to generate the super-resolution microscopic image, and the details are not repeated.

In the microscopic imaging method provided in this embodiment, the super-resolution microscopic imaging can be achieved by acquiring at least two original images, thereby improving the real-time performance and throughput of imaging and effectively reducing dye photobleaching and sample optical loss: spatial domain reconstruction instead of frequency domain reconstruction is used, and artifacts are reduced.

FIG. 14 is a structural diagram of an electronic device according to this embodiment. The electronic device includes a memory, a processor, and a computer program stored in the memory and executable by the processor. The processor, when executing the program, performs the microscopic imaging method in the preceding embodiments. An electronic device 30 shown in FIG. 14 is merely an example and is not intended to limit the function and use scope of the embodiments of the present disclosure.

As shown in FIG. 14, the electronic device 30 may be in the form of a general computing device, for example, a server device. Components of the electronic device 30 may include, but are not limited to, at least one processor 31, at least one memory 32, and a bus 33 connecting different system components (including the memory 32 and the processor 31).

The bus 33 includes a data bus, an address bus, and a control bus.

The memory 32 may include a volatile memory, such as a random-access memory (RAM) 321 and/or a cache memory 322, and may further include a read-only memory (ROM) 323.

The memory 32 may further include a program/utility 325 having a group of program modules 324 (at least one program module 324). Such program modules 324 include, but are not limited to, an operating system, one or more application programs, and other program modules and program data. Each or a certain combination of these examples may include implementation of a network environment.

The processor 31 executes computer programs stored in the memory 32 to perform various functional applications and data processing, such as the microscopic imaging method in the preceding embodiments of the present disclosure.

The electronic device 30 may also communicate with one or more external devices 34 (for example, a keyboard, a pointing device, and the like). The communication may be performed through an input/output (I/O) interface 35. Moreover, the model generation device 30 may communicate with one or more networks (such as a local area network (LAN), a wide area network (WAN), and/or a public network, for example, the Internet) through a network adapter 36. As shown in FIG. 14, the network adapter 36 communicates with other modules of the model generation device 30 via the bus 33. It is to be understood that although not shown in the figure, other hardware and/or software modules may be used in conjunction with the model generation device 30. The other hardware and/or software modules include, but are not limited to, microcode, a terminal driver, a redundant processor, an external disk drive array, a redundant array of independent disks (RAID) system, a tape driver, a data backup storage system, and the like.

It is to be noted that although several units/modules or subunits/sub-modules of the electronic device are mentioned in the preceding detailed description, this division is merely illustrative and not mandatory: In fact, according to the embodiments of the present disclosure, features and functions of two or more units/modules described above may be embodied in one unit/module. Conversely, features and functions of one unit/module described above may be further divided into and embodied by multiple units/modules.

This embodiment further provides a computer-readable storage medium configured to store computer programs, which when executed by a processor, cause the processor to perform the steps in the microscopic imaging method in the preceding embodiments.

More specific examples of the readable storage medium may include, but are not limited to, a portable disk, a hard disk, a random-access memory, a read-only memory, an erasable programmable read-only memory, an optical storage device, a magnetic storage device, or any suitable combination thereof.

In a possible embodiment, the present disclosure may also be implemented in the form of a program product, which includes program codes. When the program product is executed on a terminal device, the program codes are used for causing the terminal device to perform the steps in the microscopic imaging method in the preceding embodiments.

The program codes for executing the present disclosure can be written in any combination of one or more programming languages. The program codes can be completely executed on a user device, partially executed on the user device, executed as an independent software package, partially on the user device and partially on a remote device, or entirely on the remote device.

Although the embodiments of the present disclosure are described above, those skilled in the art should understand that the embodiments are merely examples and the scope of the present disclosure is defined by the appended claims. Those skilled in the art can make various changes or modifications to these embodiments without departing from the principles and essence of the present disclosure, but these changes and modifications all fall within the scope of the present disclosure.

1. An illumination chip for a microscopic imaging apparatus, comprising:
an illumination array structure comprising a substrate and a plurality of illumination units periodically distributed on the substrate; and
an illumination well disposed on a surface, extending along the plurality of illumination units, of the illumination array structure, wherein the illumination well is divided into a plurality of placement units which are configured to place samples, and each of the plurality of placement units is disposed above a corresponding one of the plurality of illumination units;
wherein illumination units of the plurality of illumination units are configured to generate, in a case where the illumination units of the plurality of illumination units are illuminated by a light source, surface plasmon structured light to excite fluorescent dyes of samples in corresponding placement units of the plurality of placement units, and generate a fluorescence signal.

2. The illumination chip of claim 1, further comprising a substrate layer disposed on the substrate, wherein the plurality of illumination units are separately disposed in the substrate layer, and the illumination well is disposed on a surface, extending along the plurality of illumination units, of the substrate layer.

3. The illumination chip of claim 2, wherein the substrate layer comprises:
a first substrate layer in which the plurality of illumination units are disposed; and
a second substrate layer configured to be disposed between an upper surface of the plurality of illumination units extending along the plurality of illumination units and a lower surface of the illumination well in contact with the substrate layer.

4. The illumination chip of claim 2, wherein material of the substrate layer comprises silicon dioxide.

5. The illumination chip of claim 1, wherein at least every two of the plurality of placement units are distributed on two sides of a corresponding one of the plurality of illumination units, respectively.

6. The illumination chip of claim 5, wherein one of the plurality of placement units is distributed in a symmetrical manner on a left side or a right side of the corresponding one of the plurality of illumination units;
wherein in a case where a respective illumination unit of the plurality of illumination units is illuminated by the light source at symmetrical illumination angles, the respective illumination unit is configured to generate the surface plasmon structured light to excite fluorescent dyes of samples in placement units disposed on the left side and the right side of the respective illumination unit.

7. The illumination chip of claim 1, wherein the plurality of illumination units are periodically distributed on the substrate and form regular polygons.

8. The illumination chip of claim 1, wherein each of the plurality of illumination units comprises an illumination pillar.

9. The illumination chip of claim 8, wherein the illumination pillar comprises an illumination cylinder.

10. The illumination chip of claim 1, wherein material of the substrate comprises light-transmissive material; and/or
material of the plurality of illumination units comprises metal material; and/or
material of the illumination well comprises opaque material.

11. A microscopic imaging apparatus, comprising:
the illumination chip for a microscopic imaging apparatus of claim 1;
a light source configured to illuminate light to the illumination chip;
a beam angle control device configured to adjust an illumination angle of the light from the light source to the illumination chip; and
an imaging processing device configured to generate at least two original images according to fluorescence signals generated on the illumination chip by the light at different illumination angles and perform superimposition processing on the at least two original images to generate a microscopic image
wherein the illumination chip for a microscopic imaging apparatus comprises:
an illumination array structure comprising a substrate and a plurality of illumination units periodically distributed on the substrate; and
an illumination well disposed on a surface, extending along the plurality of illumination units, of the illumination array structure, wherein the illumination well is divided into a plurality of placement units which are configured to place samples, and each of the plurality of placement units is disposed above a corresponding one of the plurality of illumination units;
wherein illumination units of the plurality of illumination units are configured to generate, in a case where the illumination units of the plurality of illumination units are illuminated by the light source, surface plasmon structured light to excite fluorescent dyes of samples in corresponding placement units of the plurality of placement units, and generate a fluorescence signal.

12. The microscopic imaging apparatus of claim 11, further comprising a collimating lens, a reflector, a lens, a dichroic mirror, an objective lens, and a tube lens;
wherein the collimating lens is configured to receive the light illuminated by the light source and emit collimated light to the reflector;
the reflector is configured to reflect the collimated light to the beam angle control device;
the beam angle control device is configured to receive the light from the reflector and emit emergent light at a first angle of emergence to the lens;
the lens is configured to emit converging light to the dichroic mirror;
the dichroic mirror is configured to reflect the received converging light to the objective lens;
the objective lens is configured to illuminate emergent light at a third angle of emergence to the illumination chip to generate the fluorescence signals;
the objective lens is further configured to collect the fluorescence signals generated on the illumination chip and transmit the fluorescence signals to the tube lens through the dichroic mirror; and
the tube lens is configured to converge the received fluorescence signals onto the imaging processing device.

13. The microscopic imaging apparatus of claim 11, further comprising a collimating lens, a first reflector, a second reflector, a first converging lens, a second converging lens, an objective lens, and a tube lens;
wherein the collimating lens is configured to receive the light illuminated by the light source and emit collimated light to the first reflector;
the first reflector is configured to reflect the light to the beam angle control device;
the beam angle control device is configured to receive the light from the first reflector and emit emergent light at a first angle of emergence to the first converging lens;
the second reflector is configured to reflect converging light converged by the first converging lens to the second converging lens;
the second converging lens is configured to illuminate emergent light at a second angle of emergence to the illumination chip;
the objective lens is configured to collect the fluorescence signals generated on the illumination chip; and
the tube lens is configured to converge the fluorescence signals collected by the objective lens onto the imaging processing device.

14. The microscopic imaging apparatus of claim 11, wherein the beam angle control device is configured to set switching time of the illumination angle to be less than 1 ms.

15. The microscopic imaging apparatus of claim 11, wherein the beam angle control device comprises a scanning galvanometer.

16. The microscopic imaging apparatus of claim 11, wherein the light source comprises any one or more of a laser light source, a light-emitting diode (LED) light source, or a mercury-vapor lamp.

17. A microscopic imaging method, comprising:
acquiring at least two original images, wherein the at least two original images are generated through fluorescent signals generated by illuminating the illumination chip for a microscopic imaging apparatus of claim 1 at different illumination angles; and
performing superimposition processing on the at least two original images to generate a microscopic image.

18. An electronic device, comprising a memory, a processor, and a computer program stored in the memory and executable by the processor, wherein the processor, when executing the computer program, performs the microscopic imaging method of claim 17.

19. A non-transitory computer-readable medium storing computer instructions which, when executed by a processor, cause the processor to perform the microscopic imaging method of claim 17.

20. The microscopic imaging apparatus of claim 11, wherein the illumination chip further comprises a substrate layer disposed on the substrate, wherein the plurality of illumination units are separately disposed in the substrate layer, and the illumination well is disposed on a surface, extending along the plurality of illumination units, of the substrate layer.
